(19) United States
(12) Patent Application Publication
(10) Pub. No.: US 2009/0153561 A1
(43) Pub. Date: Jun. 18, 2009

(54) METHOD AND APPARATUS FOR CAPTURING SCREEN BASED ON WDDM

(75) Inventors: Chengkun Sun, Beijing (CN); Hongwei Li, Beijing (CN); Fei Zhou, Beijing (CN); Yueguang Jiao, Beijing (CN)

Correspondence Address: OSHA LIANG L.L.P., TWO HOUSTON CENTER, 909 FANNIN, SUITE 3500, HOUSTON, TX, 77010, US

(73) Assignees: Beijing Lenovo Software Ltd., Beijing (CN); LENOVO (BEIJING) LIMITED, Beijing (CN)

(21) Appl. No.: 12/336,316

(22) Filed: Dec. 16, 2008

(30) Foreign Application Priority Data
Dec. 17, 2007 (CN) 200710179715.8

(51) Int. Cl. G06T 11/20

(52) U.S. Cl. 345/441

(57) ABSTRACT

The present invention relates to a technique of capturing screen. It discloses a method for capturing screen based on WDDM, which is aimed at solving the problem that the existing techniques are not suitable for Vista. The method comprise the steps of outputting commands of drawing image by an image display processing engine; analyzing the commands of drawing image by a filter driver, determining whether a display adapter can execute the commands in accordance with the registered capacities of the display adapter, and transmitting the commands to the display adapter if the display adapter can execute the commands; generating image data to be displayed in accordance with the commands by the display adapter, and transmitting the generated image data back to the filter driver; and buffering the image data to be displayed in the filter driver. The present invention also discloses a computer system with a plurality of displays employing the method described above. The present invention can be easily implemented, and the captured screen image and the image on the local display terminal have the same image quality.

### BACKGROUND OF THE INVENTION

1. Field of Invention

The present invention relates to a technique of capturing screen and, in particular to a method and apparatus for capturing screen based on WDDM (Windows Vista Display Driver Model).

2. Description of Prior Art

With the development of network technology, applications such as desktop sharing, remote monitoring and maintenance, which are realized by capturing and compressing the desktop images of a computer and then displaying them on another computer, remote terminal or remote display device, have become more popular. Taking desktop image capture for NT-based XP operating system as an example, in the prior art, for the purpose of remote sharing and monitoring, following steps should be carried out: 1) loading XDDM (XP Display Driver Model) filtering/mapping display driver program that mapping each update of current screen, such as Mirror or DDI (Device Driver Interface); 2) compressing the mirrored data, and recording it in the form of parallel streams; 3) transmitting the compressed data to a remote display terminal by means of TCP/IP etc. for display.

With Vista's being released into market, Microsoft™ has begun to use a brand new desktop displaying architecture called WDDM, which is different from XDDM (XP Display Driver Model), in Vista and operating systems succeeding Vista. In the WDDM displaying architecture, operating system supports content protection and desktop displaying having Aero effect. The problem with the desktop capture for Vista is as follows. In order to enable Aero effect to be supported by the captured desktop image, there is a need for capturing image data being displayed which had been processed by the display adapter. However, all the image data to be displayed in Vista is encrypted. Therefore, except for the prescribed display terminals, these image data can not be displayed on any other terminals. Otherwise, if capturing is done to the image data which is not processed by the display adapter, then Areo effect can not be supported, and hence the experience of the remote user will deteriorate sharply. As a result, techniques for capturing screen image in the prior art is not suitable to Vista operating system.

### SUMMARY OF THE INVENTION

An object of the present invention is to provide a method and apparatus for capturing screen based on WDDM, which allows for capturing the Vista screen image completely and supporting remote displaying having Aero effect.

In order to achieve the above object, according to the present invention, there is provided a method for capturing screen based on WDDM comprising the steps of: outputting commands of drawing image by an image display processing engine; analyzing the commands by a filter driver, determining whether a display adapter can execute the commands in accordance with the registered capacities of the display adapter, and transmitting the commands to the display adapter if the display adapter can execute the commands; generating image data to be displayed in accordance with the commands by the display adapter, and transmitting the generated image data back to the filter driver; and buffering the image data.

The method described above may further comprise outputting the buffered image data to an output port of a prescribed backup display device from the filter driver.

Wherein the outputting step may comprises the steps of determining whether the current buffered image data to be output is updated as compared with the previous image data which has been output, and outputting the updated part of the image data to the input port of a prescribed backup display device when an update exists.

According to another aspect of the present invention, there is provided a computer system having a plurality of displays comprising: a host; at least two displays connected to the host; wherein the host comprises: an image display processing engine, connected to a filter loading unit, for outputting commands of drawing image to the filter loading unit; a filter loading unit connected to the image display processing engine at one end and connected to a display adapter at the other end, for determining whether the display adapter can execute the commands in accordance with the registered capacities of the display adapter when receiving the commands, and transmitting the commands to the display adapter if the display adapter can execute the commands, and buffering the image data to be displayed sent by the display adapter; and a display adapter connected to the filter loading unit, for generating image data to be displayed in accordance with the received commands, and transmitting the generated image data back to the filter driver.

The at least two displays are connected to the host in such a manner that at least one of the at least two displays is connected to the output port of the display adapter in the host used for displaying image data, and at least one of the other displays is connected to the output port of the filter loading unit in the host used for displaying image data.

In order to overcome the shortcoming of the existing techniques of capturing screen which can not be applied to Vista operating system, the prevent invention loads a filter driver between a real display adapter and an image display processing engine, uses the filter driver to take over the registration of the display adapter's capacities and to issue interfaces of image drawing for the image display processing engine, transmits the screen image generated by the display adapter to the filter driver for buffering it, and then forwards it to the remote image displaying terminal for display. In the present invention, the screen image data output by the filter driver and the screen image data output by the display adapter are completely identical. Therefore, the screen image data output by the filter driver can support Aero effect of Vista, and the remote display terminal can achieve the same displaying effect as that of the local display terminal. Furthermore, because the screen image data is captured before the display adapter outputs them, there is no need for the remote terminal to perform decryption. The present invention can be implemented easily, and the captured screen image and the image on the local display terminal have the same quality.

### BRIEF DESCRIPTION OF THE DRAWINGS

FIG. 1 is a flowchart of the method for capturing screen based on WDDM according to the present invention;

FIG. 2 is a schematic structure diagram of the computer system having a plurality of displays according to the present invention.

### DETAILED DESCRIPTION OF THE PREFERRED EMBODIMENTS

Now, the present invention will be described in detail in conjunction with the embodiments with reference to the accompanying drawings.

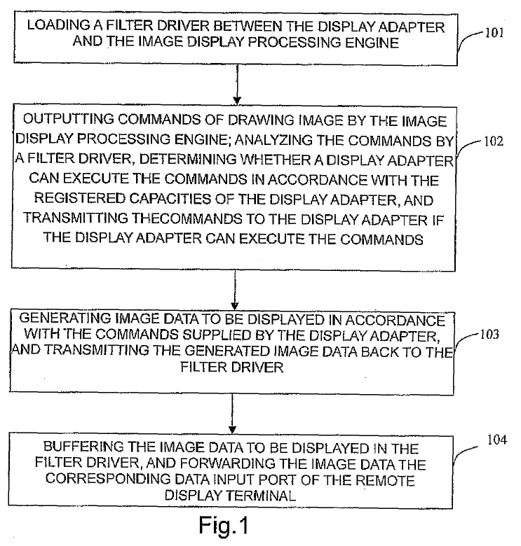

FIG. 1 is a flowchart of a method for capturing screen based on WDDM according to an embodiment of the present invention. As shown in FIG. 1, the method for capturing screen based on WDDM according to the present invention comprises the steps as follows.

Step 101: loading a filter driver between a display adapter and an image display processing engine. In this embodiment, the image display processing engine can be a core service of the operating system. The display adapter is the combination of software and hardware having the ability of processing images to be displayed, such as a display card and its driver.

First of all, the filter driver is loaded such that the filter driver takes over the registration interface of the core service Dxgkrnl.sys in the operating system. Core service Dxgkrnl.sys is a system file used by the operating system to accomplish image display management, and is involved in all the image generation managements implemented by the system. Then, a display driver is loaded. Since the registration interface of the core service Dxgkrnl.sys has been taken over by the filter driver, the setting/command interface requested by the operating system, which should be registered with the core service Dxgkrnl.sys finally, is registered with the filter driver by the display driver first. And finally, the filter driver further registers the setting/command interface, which has been registered with the filter driver, with the core service Dxgkrnl.sys. As such, a proxy is established between the display driver and the core service, and the command exchange between the display driver and the core service can be coordinated by the filter driver, thereby screen image generation can be carried out.

Step 102: outputting commands of drawing image by the image display processing engine; analyzing the commands of drawing image by a filter driver, determining whether the display adapter can execute the commands of drawing image in accordance with the registered capacities of the display adapter, and transmitting the commands of drawing image to the display adapter if the display adapter can execute the commands of drawing image. After receiving the commands of drawing screen image, the operating system transmits these commands to the filter driver via the core service Dxgkrnl.sys. After receiving the commands of drawing screen image, the filter driver analyzes these commands and determines whether the display driver can support the received commands in accordance with various capacities registered with the filter driver by the display driver. If so, it returns a message indicating the commands of drawing image can be executed. Otherwise, it returns a message indicating the commands of drawing image can not be executed. When receiving the message indicating the commands of drawing image can not be executed, the core service Dxgkrnl.sys feeds it back to the user. When the display driver can execute the commands of drawing image, the commands are transmitted to the display adapter.

Step 103: generating image data to be displayed in accordance with the commands by the display adapter, and transmitting the generated image data back to the filter driver. After receiving the commands of drawing image, the display adapter executes those commands, draws the image to be displayed, and sends the finished image data to the filter driver.

Step 104: buffering the image data to be displayed in the filter driver, and forwarding the image data the corresponding data input port of the remote display terminal. The filter driver buffers the screen image data to be displayed generated in step 103 and transmits it to the display adapter. After being encrypted, this data will be displayed by the local display terminal. At the same time, the buffered data is transmitted to the corresponding data input port of the remote display terminal and displayed by the same terminal. As such, applications such as remote display of local screen image and image sharing/monitoring can be realized. Since the screen image data buffered in the filter driver and the screen image data output by the display adapter is completely identical, the buffered screen image data can fully support Aero effect. Furthermore, because the screen image data buffered and forwarded to the remote display terminal is not encrypted by the display adapter, the remote display terminal can directly display the received data without performing decryption.

Preferably, after buffering the image data to be displayed in the filter driver (step 104), it can determines whether the image data to be displayed is updated. If the image data is updated, then forward it. Otherwise, the buffered image data will not be forwarded. Of course, it is also possible to output the data of the updated area to the prescribed port of the remote display terminal after an update of the image data was detected.

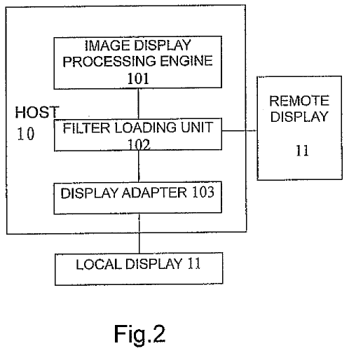

FIG. 2 is a schematic structure diagram of the computer system having a plurality of displays according to an embodiment of the present invention. As shown in FIG. 2, the computer system having a plurality of displays according to an embodiment of the present invention is provided with a host 10 and at least two displays 11 connected to the host. In other words, at least one of the at least two displays is local display, and at least one of the at least two displays is remote display.

Wherein the host 10 is provide with an image display processing engine 101 connected to a filter loading unit 102 for outputting commands of drawing image to the filter loading unit 102; a filter loading unit 102 connected to the image display processing engine 101 at one end and connected to a display adapter 103 at the other end, for determining whether the display adapter 103 can execute the commands of drawing image in accordance with the registered capacities of the display adapter, when receiving the commands, and transmitting the commands to the display adapter 103 if the display adapter can execute the commands, and buffering the image data to be displayed sent by the display adapter 103; and a display adapter 103 connected to the filter loading unit 102, for generating image data to be displayed in accordance with the received commands, and transmitting the generated image data back to the filter driver 102.

The filter driver 102 is the proxy which is set between the image display processing engine 101 and the display adapter 103. The filter driver 102 takes over the registration of the display adapter's capacities, and receives the commands of the image display processing engine 101 and sends them to the display adapter 103 as well. Those skilled in the art should understand that the image display processing engine 101 can be implemented as the core service Dxgkrnl.sys of the operating system, and the display adapter 103 can be implemented as the display card and its driver.

In the present invention, the at least two displays are connected to the host. In particular, at least one of the displays is connected to the output port of the display adapter 103 in the host 10 used for displaying image data, i.e. local display output; at least one of displays is connected to the output port of the filter loading unit 102 in the host 10 used for displaying image data, i.e. remote display output.

Preferably, after buffering the image data to be displayed, the filter loading driver 102 determines whether the current image data to be displayed is updated as compared with the previous image data which has been displayed. If the image data is updated, then forward it to the remote image output pod. Otherwise, the buffered image data will not be forwarded. Of course, it is also possible to forward the data of the updated area to the prescribed port of the remote display terminal after an update of the image data was detected.

The embodiments described above are just the optimum embodiments of the present invention, and should not be construed as limiting the scope of the present invention.

What is claimed is:

1. A method for capturing screen based on WDDM comprising the steps of:
outputting commands of drawing image by an image display processing engine;
analyzing said commands of drawing image by a filter driver, determining whether a display adapter can execute said commands of drawing image in accordance with registered capacities of said display adapter, and transmitting said commands of drawing image to said display adapter if said display adapter can execute said commands of image drawing;
generating image data to be displayed in accordance with said commands of image drawing by said display adapter, and transmitting the generated image data back to said filter driver; and
buffering said image data.

2. The method according claim 1, further comprises a step of
outputting the buffered image data to an input port of a prescribed backup display device from said filter driver.

3. The method according claim 1, wherein said filter driver is loaded between said image display processing engine and said display adapter; said display adapter registers its capacity information with said filter driver; and said display driver outputs the commands for said image display processing engine.

4. The method according claim 2, wherein the step of outputting the buffered image data to an input port of a prescribed backup display device from said filter driver comprises:
determining whether the current buffered image data to be output is updated as compared with the previous image data which has been output, and outputting the updated part of the image data to the input port of a prescribed backup display device when an update exists.

5. A computer system having a plurality of displays comprising:
a host;
at least two displays connected to said host;
wherein said host comprises an image display processing engine connected to a filter loading unit for outputting commands of drawing image to said filter loading unit; a filter loading unit connected to said image display processing engine at one end and connected to a display adapter at the other end, for determining whether said display adapter can execute said commands of drawing image in accordance with the registered capacities of said display adapter when receiving said commands of drawing image, and transmitting said commands of drawing image to said display adapter if said display adapter can execute said commands of drawing image, and buffering said image data to be displayed sent by said display adapter; and a display adapter connected to said filter loading unit for generating image data to be displayed in accordance with the received commands, and transmitting the generated image data back to said filter driver.

6. The computer system according claim 5, wherein the at least two displays are connected to said host in such a manner that at least one of the at least two displays is connected to an output port of the display adapter in said host used for displaying image data, and at least one of the other displays is connected to the output port of the filter loading unit in said host used for displaying image data.
